(19) United States
(12) Patent Application Publication
(10) Pub. No.: US 2021/0008430 A1
(43) Pub. Date: Jan. 14, 2021

(54) TRAJECTORY ASSISTANCE SYSTEMS AND METHODS THEREOF

(71) Applicant: Maxualize LLC, Rochester, NY (US)

(72) Inventors: Dante Robert Pennacchia, Rochester, NY (US); James F. Munro, Ontario, NY (US)

(21) Appl. No.: 16/728,967

(22) Filed: Dec. 27, 2019

Related U.S. Application Data
(60) Provisional application No. 62/872,690, filed on Jul. 10, 2019.

(51) Int. Cl. A63B 69/36

(52) U.S. Cl. CPC A63B 69/3658; A63B 69/3691; A63B 69/3676

(57) ABSTRACT

A trajectory assistance system and method includes an image capturing device and an interface system coupled to at least one processor and a memory coupled to the processor which is configured to be capable of executing programmed instructions comprising and stored in the memory to capture, with the image capture device, image data comprising a surface, an object, and a designated location spaced from the object on the surface. Spatial data and surface data relating to the surface, the object and the designated location is determined. An overall trajectory, a starting direction, and an initial velocity of the object to reach the designated location is computed. The computed overall trajectory, the starting direction, and the initial velocity of the object are provided.

This application claims the benefit of U.S. Provisional Patent Application Ser. No. 62/872,690, filed Jul. 10, 2019, which is hereby incorporated by reference in its entirety.

### FIELD

This technology generally relates to trajectory assistance systems and methods and, more particularly, to electronic golf aid systems and methods that compute a path or trajectory of a golf ball rolling on a surface.

### BACKGROUND

The prevalence and utility of golfing aids has increased dramatically in recent years, due to the availability of low-cost electronics, optics, and digital processors which have expanded the availability and usefulness of electronic displays, rangefinders, and even 3D cameras. These devices in turn have proven beneficial as training devices from tee shots to putts and every type of golf shot in between.

The art of putting is especially difficult to master, as a putt is subject to a host of variables beyond the golfers control, such as the topography of the green, the grain of the green, the speed (or resistance) of the green, and even the wetness or moisture content of the green. Most golfing aids do not capture and process half of these variables, and even when they do the variable data that is processed is imprecise and the algorithms that are executed are simplifications.

For example, while the 3D topography of a green may be captured and input to the algorithm, the 3D image may have low resolution and poor accuracy. Alternately, if the purpose of the golfing aid is to suggest a putting direction for the putt, prior putting aids simply fail to take into account a sufficient number of factors, such as the resistance a green offers to a rolling golf ball, and thus do not provide the necessary level of effectiveness for adoption.

### SUMMARY

A trajectory assistance system includes an image capturing device and an interface system coupled to at least one processor and a memory coupled to the processor which is configured to be capable of executing programmed instructions comprising and stored in the memory to capture, with the image capture device, image data comprising a surface, an object, and a designated location spaced from the object on the surface. Spatial data and surface data relating to the surface, the object and the designated location is determined. An overall trajectory, a starting direction, and an initial velocity of the object to reach the designated location is computed. The computed overall trajectory, the starting direction, and the initial velocity of the object are provided with the interface system.

A non-transitory computer readable medium having stored thereon instructions comprising executable code which when executed by at least one processor, cause the processor to obtain image data comprising a surface, an object, and a designated location spaced from the object on the surface. Spatial data and surface data relating to the surface, the object and the designated location is determined. An overall trajectory, a starting direction, and an initial velocity of the object to reach the designated location is computed. The computed overall trajectory, the starting direction, and the initial velocity of the object are provided.

A method comprising capturing, by an image capture device coupled to a computing device, image data comprising a surface, an object, and a designated location spaced from the object on the surface. Spatial data and surface data relating to the surface, the object and the designated location is determined by the computing device. An overall trajectory, a starting direction, and an initial velocity of the object to reach the designated location is computed by the computing device. The computed overall trajectory, the starting direction, and the initial velocity of the object are provided by an interface system coupled to the computing device.

Accordingly, examples of the claimed technology provide a number of advantages including providing more accurate and effective trajectory systems and methods. Examples of the claimed technology accurately compute a trajectory, such as a curved or piecewise linear trajectory, of a putt along a playing surface, such as a golf green, taking into account a number of factors, such the topography of the green, the speed or resistance of the green surface, the distance between the ball and the cup, and/or the initial speed of the golf ball by way of example. Additionally, examples of the claimed technology provide guidance feedback data to assist with correlating the computed trajectory to another action, such as an actual swing of a golf putter to match the trajectory.

### BRIEF DESCRIPTION OF THE DRAWINGS

FIG. 1 is a block diagram of a prior art golf putting aid system;

FIG. 2 is an orthographic view of an example of a golf green and a block diagram of an example of a golf putting aid system;

FIG. 3 is another orthographic view of the example of the golf green shown in FIG. 2 an example of computed piecewise linear trajectory of a golf ball;

FIG. 4 is a flow chart of an example of a method for computing the trajectory of a golf ball on a golf green;

FIG. 5A is a side-view of a diagram of an example of the golf ball on a portion of the golf green shown in FIGS. 2 and 3 illustrating examples of forces acting on the golf ball;

FIG. 5B is a plan view of a diagram of the golf ball on a portion of another golf green illustrating examples of forces acting on the golf ball;

FIG. 6 is a screenshot of an example of a graphical user interface that visually conveys a direction and magnitude of a practice putt swing and how the direction and magnitude compare to a computed direction and magnitude along with the golf ball on yet another golf green;

FIG. 7 is a flow chart of an example of a method for using the golf putting aid system shown in FIG. 2; and

FIG. 8 is a screenshot of an example of a graphical user interface that visually conveys of a computed aim point displayed to a golfer such that the ball reaches the cup when putted.

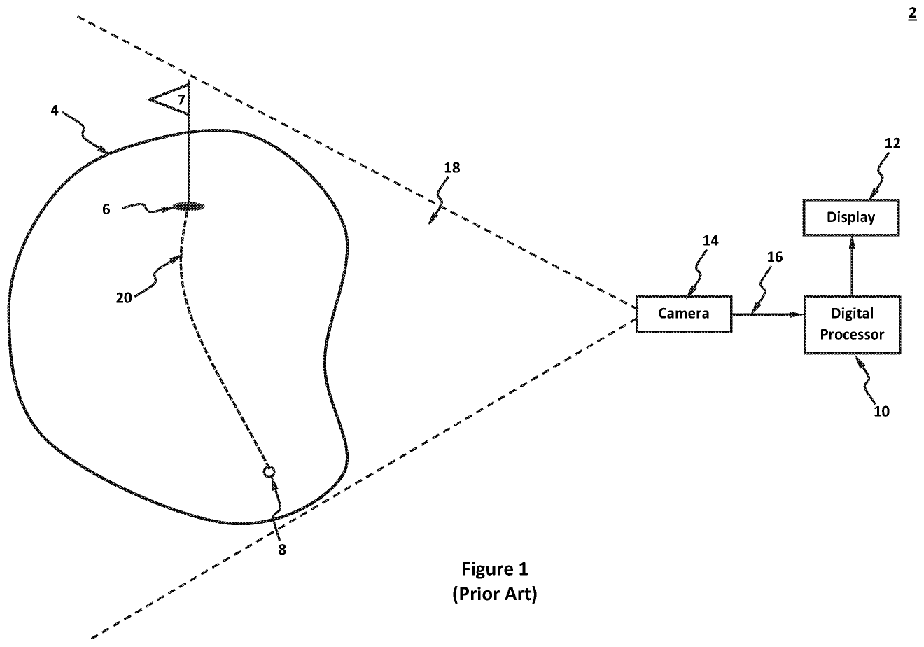

### DETAILED DESCRIPTION

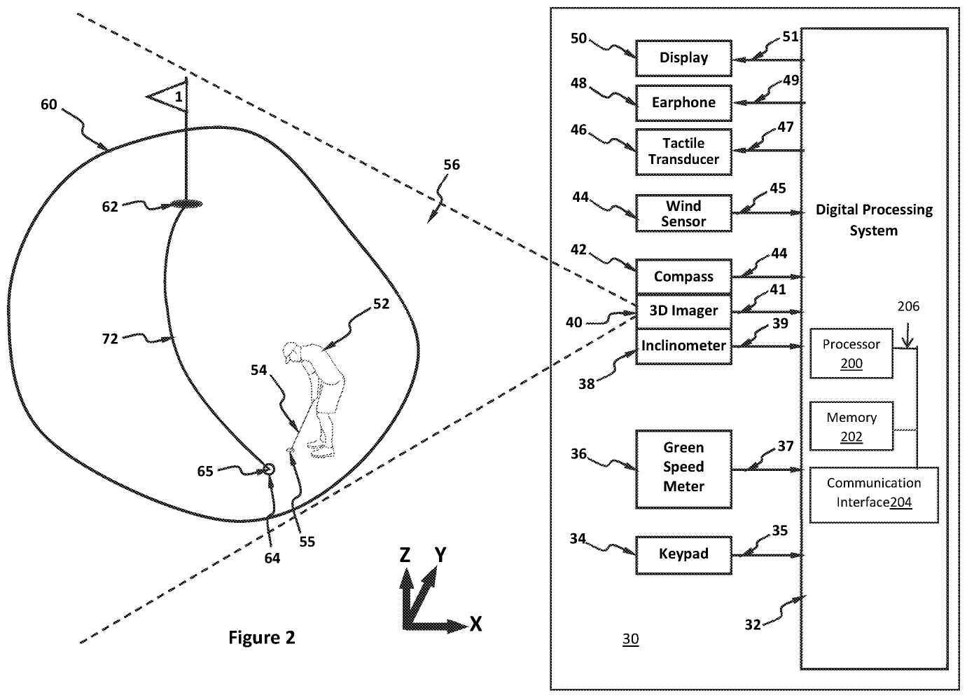

A golf putting aid system 30 in accordance with examples of the claimed technology is illustrated in FIG. 2. The golf putting aid system 30 includes a digital processing system 32, a keypad 34, a green speed meter device 36, an inclinometer device 38, a 3D imager device 40, a compass device 42, a wind sensor device 44, a tactile transducer 46, an earphone device 48, and a display device 50, although the golf putting aid system 30 can have other types and/or other numbers of other system, devices, components, or other elements in other configurations. Additionally, one or more of these elements of the golf aid putting system 30 may be integrated with the golf putting aid system 30 or separate from, but coupled to the golf putting aid system 30. The claimed technology provides a number of advantages including providing more accurate and effective trajectory assistance systems and methods. In particular, examples of the golf putting aid systems and methods are configured to compute a trajectory, such as a curved or piecewise linear trajectory, of a putt along a playing surface, such as a golf green, taking into account multiple factors, such as the topography of the green, the speed or resistance of the green, the distance between the golf ball and the cup, and/or the initial speed of the golf ball by way of example.

Referring more specifically to FIG. 2, in one example a golf putting aid system 30 is operative with an exemplary golf green 60 having a golf ball 64, a cup 62, and a golfer 52 having a putter 54 which in turn has a putting head 55, although in other examples the golf putting aid system 30 for other types of applications, such as robotics by way of example only, may be a trajectory assistance system. A coordinate reference system is also illustrated in FIG. 2 in which the Z-axis is in the vertical or upwards direction whereas, and the X and Y axes define the horizontal plane (note that X, Y, and Z axes are perpendicular to one another), although this technology can be used in other types of applications that involve trajectory determinations from one location to another, such as a robotics application by way of example only. The selection of the origin is arbitrary and in this example is at the location of the golf ball 64 on the golf green 60. The direction of the X-axis is also arbitrary and can be selected to be the direction from the golf ball 64 to the cup 62, projected onto the horizontal plane.

The digital processing system 32 includes a processor 200, a memory 202, and a communication interface 204 which are coupled together by one or more buses or other links 206, although the digital processing system 32 can have other types and/or numbers of other systems, devices, components, or other elements in other configurations. The processor 202 may execute programmed instructions stored in the memory 202 or elsewhere for any number of the functions and/or other operations illustrated and/or described by way of the examples herein. The processor 202 may include one or more CPUs or general purpose processors with one or more processing cores, for example, although other types and/or numbers of processor(s) can be used.

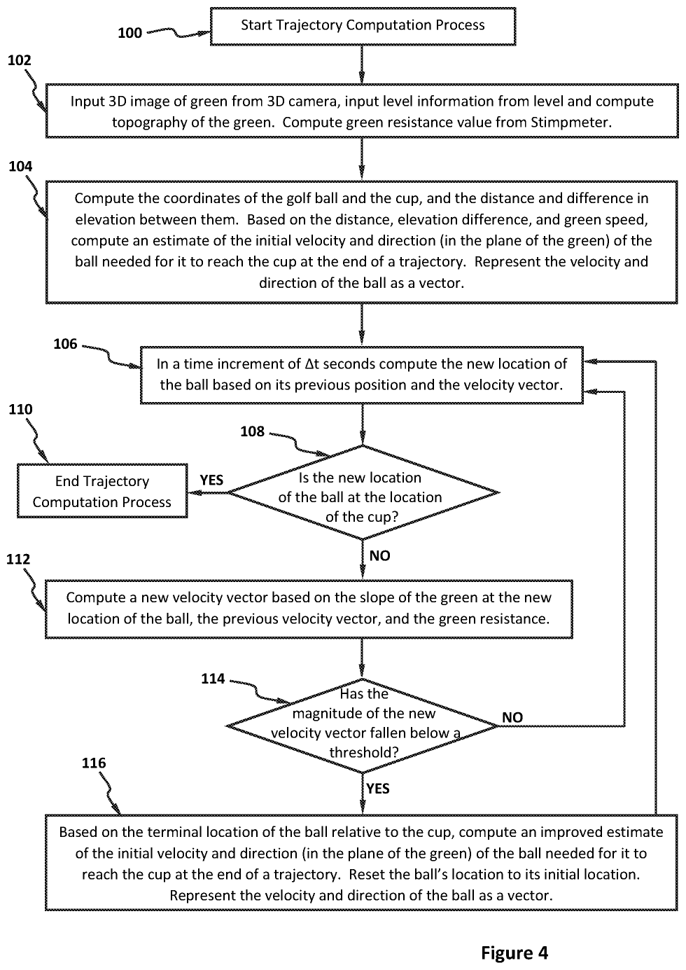

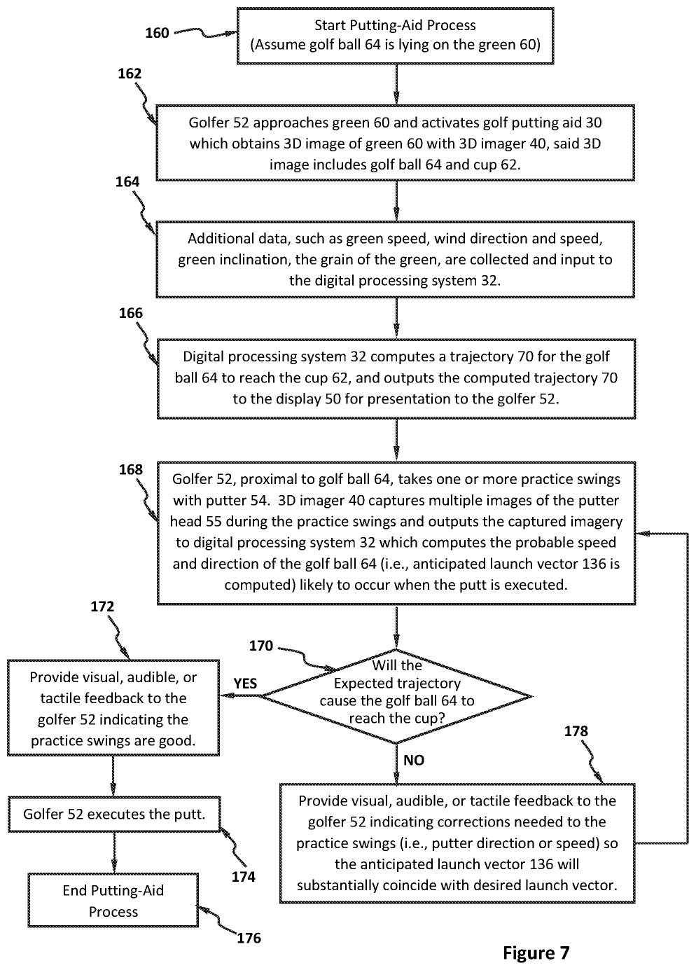

The memory 202 stores programmed instructions and data for functions and/or other operations illustrated and/or described by way of the examples herein for execution by the processor 200, although some or all of these instructions and data may be stored elsewhere. In this example, the memory 202 may store programmed instructions and data for computing or otherwise determining a computed trajectory 72 of a golf ball 64 on a green 60 as illustrated and described by way of the examples herein including in FIGS. 4 and 7. Additionally, in this example, the memory 202 may store programmed instructions and data for image processing to capture image data, such as one or more images and/or videos of a green with a golf ball and a cup, and object recognition processing to identify one or more objects in the one or more captured images and/or videos, such as the outer perimeter and contours of the green as well as the golf ball and cup. A variety of different types of memory storage devices, such as a random access memory (RAM), a read only memory (ROM), flash memory, hard disk, CD ROM, USB thumb-drive, or other computer readable medium which is read from and/or written to by a magnetic, optical, or other reading and/or writing system coupled to the processor 200, can be used for the memory 202.

The communication interface 24 operatively couples and communicates between the digital processing system 32 and one or more of the keypad 34, the green speed meter device 36, the inclinometer device 38, the 3D imager device 40, the compass device 42, the wind sensor device 44, the tactile transducer 46, the earphone device 48, and the display device 50 which are all coupled together by the one or more communication network(s) which may be direct internal or external hardwire connections and/or may by wireless connections, although other types and/or numbers of communication networks or systems with other types and/or numbers of connections and/or configurations to other devices and/or elements can be used.

By way of example only, the digital processing system 32 can be a conventional microprocessor with an external memory or the digital processing system 32 can be a microcontroller with all memory located onboard. In another example, the digital processing system 32 can be a digital signal processor (DSP) integrated circuit, which is a microcomputer that has been optimized for digital signal processing applications. In yet another example, the digital processing system 32 can include a graphical processing unit (GPU) integrated circuit, which is a microcomputer that has been optimized for parallel-processing applications. The digital processing system 32 could for example be as simple as an eight-bit integer device for low-cost usage or in another example the digital processing system 32 can be a thirty-two bit or sixty-four bit or higher floating point device or system for higher performance when cost is less of an issue. Also, by way of example only, the digital processing system 32 can include an FPGA (Field-programmable gate array), a CPLD (complex programmable logic device), or even an ASIC (application specific integrated circuit) which are attractive for use in this example owing to their compact and cost-effective hardware implementations.

The keypad 34 is a keyboard device for manually entering data into golf putting aid 30, such as, for example, data pertaining to the grain of a green 60, although other types and/or numbers of input devices or systems may be used, such as voice activated by way of example. The keypad 34 has an output electronically coupled to an input of digital processing system 32 through keypad data line 35, although other types of connections may be used, including for example other wired or wireless connections. The keypad 34 can be a full QWERTY-style keyboard or have a 12-key phone-style layout, or any other layout suitable for entering numeric, alphanumeric, symbolic, or iconic data. The keys can be soft keys, such as used in a touch-display (in which case, for example, keypad 34 can be integrated with display device 50) or hard keys in which they implemented electro-mechanically.

The green speed meter device 36 is a device for measuring the speed, or more precisely, in one example a resistance a playing surface of the green 60 offers to a golf ball 64 rolling across it. The green speed meter device 36 has an output electronically coupled to an input of digital processing system 32 via speed meter data line 37, although other types of connections may be used, including for example other wired or wireless connections. By way of example, the green speed meter device 36 can be a device similar to an electronic version of the Stimpmeter (Stimpmeter is a registered trademark of the USGA, describing goods associated with an “apparatus for measuring the relative speed of a golf putting green.”) in which a golf ball 64 is rolled down an inclined plane before reaching the surface of a green 60 whereinafter the distance the golf ball 64 rolls after reaching the green 60 is indicative of the green's speed and inversely proportionate to the rolling resistance of the golf ball 64 across the surface of the green 60. Since both terms, “resistance” and “speed”, refer to the same quantity of a golf green, namely how quickly a rolling golf ball's velocity decreases as it rolls across a surface of the green, the terms will be used interchangeably in the present disclosure even though, technically, they have distinct and separate physical definitions. The resistance the green 60 offers to the golf ball 64 is an example of an input parameter when computing a trajectory as illustrated and described in examples herein. For example, if the green's resistance was zero the golf ball 64 will roll forever, and if the resistance was infinite the golf ball 64 would not roll at all. In other examples, the green speed and/or resistance data may be obtained by the digital processing system 32 in other manners, such as by manual input by keypad 34 or by coupling to and retrieving from a database which has this green speed and/or resistance data stored, e.g. a server at the golf course, or may obtain prior stored green speed and/or resistance data which can be used as an approximation by way of example only.

The inclinometer device 38 (also referred to herein as a level) is nominally mechanically coupled to 3D imager device 40 and outputs inclination or tilt information, such as the front-to-back or side-to-side tilt, of the 3D imager device 40 to the digital processing system 32. The inclination or tilt information may be used, because, while the 3D imager device 40 can produce detailed topographical information about the surface of green 60, the topographical information can appear to be tilted if the 3D imager device 40 happens to be tilted during the 3D imaging process. The inclination data output from the inclinometer device 38 can be used by the digital processing system 32 to remove the effects of any inadvertent tilt introduced by the 3D imager device 40 being held, mounted, or otherwise oriented in a tilted manner. The inclinometer device 38 has an output electronically coupled to an input of digital processing system 32 via inclinometer data line 39, although other types of connections may be used, including for example other wired or wireless connections. The inclinometer device 38 can be an integrated circuit, such as the ADIS 16203 from Analog Devices, Inc. (Norwood, Mass., USA 02062), and the inclinometer device 38 can be attached to the 3D imager device 40 as mentioned earlier. Alternately, in another example the inclinometer device 38 can be mechanically integrated into the 3D imager device 40 or even electronically integrated into 3D imager device 40 so the 3D topographical image of the green 60 has had the tilt corrected thereby relieving the need of digital processing system 32 from performing the tilt correction, although other manners for obtaining this tilt data may be used.

The 3D imager device 40 is a device that captures or creates a 3D image of a target object, such as the surface of a golf green 60, although other manners for capturing or otherwise obtaining 3D image data or other types of image data may be used. The 3D imager device 40 has a field of view 56 and an output electronically coupled to an input of digital processing system 32 via 3D camera data line 41, although other types of connections may be used, including for example other wired or wireless connections. The 3D imager device 40 can be an active device such as a time-of-flight (“TOF”) range camera in which the entire field of view 56 is illuminated with modulated light emitted by the range camera which subsequently receives back a portion of the emitted light, and process the received light to determine a distance to a small patch of the surface for each corresponding pixel of the 3D imager 40. Alternately, the 3D imager device 40 can include a scanning LIDAR (light detection and ranging) or utilize projected structured light, and although passive 3D imagers, such as those based on stereoscopic cameras can be used as 3D imager 40, stereoscopic methods are probably unsuitable because the golf green's 60 surface is generally featureless which precludes the generation and processing of a stereoscopic disparity matrix from which the topography of the green 60 can be determined.

The 3D imager device 40 outputs a digital representation of the 3D surface of the green 60 to digital processing system 32. In this example, the 3D coordinate system used in the representation can be Cartesian, such as the X-Y-Z axes denoted in FIG. 2, or p-θ-ϕ coordinates commonly used in a spherical coordinate system. The digital representation can include an array of pixels, wherein the number of pixels is between 1000 and 100,000,00, and there can be one or more such 3D images captured and uploaded to the digital processing system 32. If more than one 3D image is captured and uploaded, the 3D image capture rate can be between one 3D image per second and 1000 3D frames per second. The 3D imager device 40 can also output a conventional 2D brightness image of the surface, the 2D image being monochrome or in color. The 3D imager device 40 can be a portable device, being held by the golfer 52 (or his or her caddy) or even attached to the golfer 52 (or attached to his or her caddy), or substantially fixed in place where the 3D imager device 40 is mounted onto a tripod or a rigid frame or gantry.

The compass device 42 is an electronic device for measuring and obtaining direction information that may be electronically communicated to digital processing system 32. In this example, the compass device 42 has an output electronically coupled to an input of digital processing system 32 via compass data line 43, although other types of connections may be used, including for example other wired or wireless connections. Additionally in this example, the compass device 42 also is nominally co-located with 3D imager 40, or in other examples mechanically coupled to 3D imager device 40 so the heading information output from compass device 42 is, for example, indicative of the direction that 3D imager device 40 is aimed. One candidate for use as the compass device 42 is the HMC6343 Three-axis Compass from Honeywell (Plymouth, Minn., 55441 USA), which has 0.1° resolution and can measure both heading and tilt. The directional or heading information output from compass device 42 can be used by digital processing system 32 to change the perspective viewing angle of the information or image data, such as an image of a computed trajectory 72, presented on display device 50 in accordance with the heading information from compass device 42.

The wind sensor device 44 is a device for measuring the magnitude and direction of the wind at or near the location of the golf ball 64, so the trajectory-computation, discussed by way of example below with reference to FIG. 4, can include the forces imparted on the golf ball 64 by the wind when determining a golf ball's 64 computed trajectory 72. The wind sensor device 44 has an output electronically coupled to an input of digital processing system 32 via wind sensor data line 45, although other types of connections may be used, including for example other wired or wireless connections. The wind sensor device 44 can include a weather-vane for determining wind direction and an anemometer for measuring wind speed, although other types of wind-sensing devices which measure one or more wind related characteristics can be utilized as well. In this example, the sensed wind information is communicated to the digital processing system 32 for inclusion in the determination of computed trajectory 72. The wind sensor device 44 can be small and portable or larger and fixed in position. By way of example only, both wind direction and wind speed sensors are available from C-TON Industries (e.g., model number DLT and SLT, respectively) Memphis, Tenn., USA, 38111. Although in this example wind speed and/or direction data is obtained and utilized, other types and/or numbers of other types of weather related data may be obtained and utilized for computing trajectory, such as current weather condition data.

The tactile transducer 46 is an electro-mechanical device that creates a mechanical sensation that can be detected by a person, such as a golfer 52. The tactile transducer 46 has an input electronically coupled to an output of digital processing system 32 via tactile transducer data line 47, although other types of connections may be used, including for example other wired or wireless connections. In this example, the tactile transducer 46 is constructed as a small electrical motor with an off-balanced weight attached to the shaft such that it produces a vibrational sensation when activated and is wirelessly coupled to the digital processing system 32, although a tactile transducer can be constructed from other types of components in other configurations and may be coupled to communicate in other manners. The tactile transducer 46 can be located in the handle of putter 54, or co-located with a display device 50 or earphone device 48, but is beneficially located proximal to, and even in physical contact with, golfer 52 to sense the tactile sensations produced by the tactile transducer 46. In this example a tactile transducer 46 can be activated by digital processing system 32 when the aim of the golfer's 52 putter 54 is substantially correct as determined by digital processing system 32 so that the golf ball 64 can be expected to follow computed trajectory 72 when the golfer 52 executes the putt. One tactile transducer 46 suitable for use in this example is the Z4FC1B1301781 from Jinlong Machinery and Electronics, Yueqing Whenzhou, Zhejiang Province, China 325603.

The earphone device 48 is an electro-mechanical device that produces audio signals in response to applied electronic signals and are typically worn by a golfer 52 in his or her ear(s). The earphone device 48 has an input electronically coupled to an output of digital processing system 32 via earphone data line 49, although other types of connections may be used, including for example other wired or wireless connections. In this example, the earphone device 48 can be activated by digital processing system 32 when the aim of the golfer's 52 putter 54 is to the left, for example, as determined by digital processing system 32 (so that the golf ball 64 can be expected to follow a trajectory to the left of computed trajectory 72 when the golfer 52 executes the putt) in which case the earphone can produce the audible message “Aim Right More” for putter aim feedback and correction, although earphone can be activated at other times and produce other types and/or numbers of audible instruction messages from a stored library of guidance instructions as well. By way of example, one pair of earphones 48 suitable for use in this example is the UH-R 2030 from USound GmbH, Graz, Austria.

The display device 50 can be a head-mounted display in which the display device 50 is attached to the golfer's 52 head located proximal to the eyes of the golfer 52 so that an image is presented to one or both eyes of the golfer 52 from an image generated by the digital processing system 32, although other types and/or numbers of other types of display devices or manners may be used. If no outside image data is allowed to be directly seen by golfer 52 (i.e., only the display image data is viewable), then the display device 50 is immersive. Immersive displays as well as non-immersive displays are suitable for use as the display device 50. In another example, the display device 50 can comprise two individual displays offset from one another, thus forming a stereoscopic pair in which one sub-display presents an image to one eye and the second sub-display presents a slightly different image to the second eye such that 3D image data can be stereoscopically presented to the golfer 52. In yet another example, the display device 50 can be a large non-head-mounted conventional display which in this example is wireless connected to the digital processing system 32 and in which the displayed image data may be viewed by the golfer 52 from a distance of at least 12 inches or more. In this example, the display device 50 has an input electronically coupled to an output of digital processing system 32 via display data line 51, although other types of connections may be used, including for example other wired or wireless connections.

The image data that is shown on the display device 50 can include the image data within the field of view 56 captured by 3D imager device 40, such as the green 60, the ball 64, the cup 62, one or computed trajectories 72, topography information of the green 60, gradient information of the green 60, an indication of the aiming point or direction that the golf putt should be shot by the golfer 52, as well as the actual putt trajectory whose image data was captured during the putting process. Furthermore, any or all of this display content can be presented in real-time to the golfer, as well as to a larger audience, and can vary in accordance with location and/or point of view and the viewing direction of the golfer 52.

In this example, the field of view 56 is the viewing angle of the 3D imager device 40 over which 3D image data can be captured. Within the field of view 56 should be at least the area of the green 60 of interest, the ball 64, the cup 62, and that portion of the green 60 between them that the golf ball 64 will traverse from the golf ball's starting position 65 to its stopping position, although the other types and/or required numbers of elements may be used. The digital processing system 32 may execute programmed instructions for object recognition to identify necessary elements in the image data, e.g. the green, ball and cup, and if not identified, then the digital processing system 32 may interact with the 3D imager to continue to capture image data until the object recognition is able to verify the presence of the necessary elements, e.g. the green, ball and cup.

As noted in the examples above, some or all of the electronic data links including the keypad data line 35, the speed meter data line 37, the inclinometer data line 39, the 3D camera data line 41, the compass date line 43, the wind sensor data line 45, the tactile transducer data line 47, the earphone data line 49, and the display data line 51 can be wireless or wired in nature. If wireless, the data links for example can be Bluetooth or Wifi. If wired the data links for example can comprise electronic conductors or even fiber optics.

Optionally digital processing system 32 can also obtain captured and recorded image data of the action of the putter head 55 during the stroke, the initial direction and velocity of the ball 64, and the actual trajectory of the ball from the start of the putt until the ball 64 comes to a stop. This recording of this image data, comprising video and/or images, can be re-played at a later time as a feedback mechanism so the golfer 52 can learn and improve his or her putting game.

The examples illustrated and described herein may also be embodied as one or more non-transitory computer readable media having instructions stored thereon for one or more aspects of the present technology, such as the memory of the assessment computing device, as described and illustrated by way of the examples herein. The instructions in some examples include executable code that, when executed by one or more processors, such as the processor(s) of the assessment computing device, cause the one or more processors to carry out steps necessary to implement the methods of the examples of this technology that are described and illustrated herein.

An example of a method of trajectory computing executed by the digital processing system 32 functions by approximating an actual continuous trajectory as a series of short, straight, line segments, although other manners for computing trajectory may be used. As the length of the line segments approaches zero, the computed trajectory 72 will also be continuous and substantially match the actual trajectory. Unfortunately, if the length of each of the line segments is zero, then there must necessarily be an infinite number of segments which is not realizable. In this example, a reasonable number of segments is between ten and 10,000 (depending primarily on the overall length of the trajectory) and in this example the length of a segment can be between 0.1 millimeter and one meter, although other numbers of segments and/or other lengths may be used.

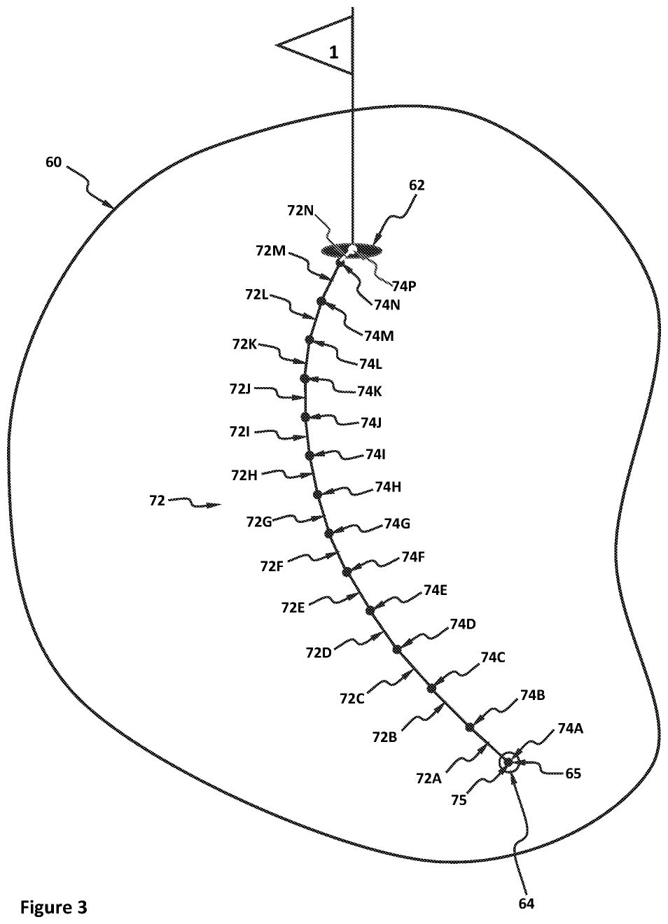

Referring now to FIG. 3, an example of a computed trajectory 72 is shown as a series of linear segments, 72A, 72B, 72C, and so on, each segment having a starting point and an ending point. For example, the starting point for a first segment 72A is point 74A, coinciding with ball starting position 65, and the ending point for first segment 72A is point 74B, while the starting point for second segment 72B is point 74B and the ending point for second segment 72B is point 74C. Each segment, 72A, 72B, 72C, and so on, comprising the computed trajectory 72 can lie on the surface of the green 60, or slightly above the green's 60 surface in accordance with the radius of the golf ball 64, the radius can be between one millimeter and ten meters, but being 21.335 millimeters for a standard golf ball.

Each segment can be treated as a vector because a segment has a starting position and a velocity and direction of travel. Using vector arithmetic, the ending position of a segment is therefore the starting position plus the velocity vector times a time increment, the time increment being between one millisecond and one second, for example. A velocity vector is computed as the velocity vector of a previous segment plus a change in velocity due to the rolling resistance of the green 60 plus an additional change in velocity due to gravity which in turn is a function of the topography—more precisely the gradient of the topography—of the green 60 at the location of the starting position of the velocity vector. Additional influences on the velocity vector, such as accelerations due to forces caused by the wind or any biases of the green 60 such as grain by way of example only, may be incorporated into the calculation of the velocity vector.

Referring now to FIG. 4, an example of a method for computing a computed trajectory 72 based on a series of line segments will now be described. This example is illustrated in a golfing environment, but the claimed technology in other examples may be utilized in the same manner for other types of applications, such as robotics by way of example only. In this particular example in step 100, the golf putting aid system 30 is activated, although in other examples other trajectory assistance systems may be used.

In step 102, the digital processing system 32 of the golf putting aid system 30 receives 3D image data which in this example is determined with object recognition to include the green 60, the golf ball 64 and the cup 62 from the 3D imager device 40, 3D camera inclination data from inclinometer device 38, green speed data on the resistance of the green to a rolling golf ball obtained from a green speed meter device 36, such as a Stimpmeter, and input with the keyboard 34 or based on a coupling to the green speed meter device 36, weather element data about a direction and magnitude of the wind from the wind sensor device 44, and the grain of the grass on the surface of the green 60 which can be manually input via keypad 34, although other types and/or combinations of data to compute a trajectory may be used. Next, the digital processing system 32 computes a topographic map of the green 60 within a field of view 56 of the 3D imager device, and also computes a gradient map of the green 60 as well which is essentially a vectorized slope map of the topographic map. After the gradient and topographic maps are computed, and all the data is input to the digital processing system 32, the data may be stored in memory 202 in this example.

In step 104, several initializing computations are performed by the digital processing system 32 of the golf putting aid system 30, such as computing the coordinates of the cup 62 (X_{C}, Y_{C}) relative to the golf ball 64—in particular the elevation of the cup 62 relative to the elevation of the golf ball 64, and the distance between them. Based on the distance and the difference in elevation, as well as, optionally, the speed or resistance of the green 60 and any other parameters that would influence the computed trajectory 72 of the golf ball 64, digital processing system 32 of the golf putting aid system 30 then computes in this example an estimated initial direction and velocity of the golf ball 64 such that the resulting computed trajectory 72 of the golf ball 64 will terminate at the cup 62. The velocity and direction estimate of the golf ball 64 at each trajectory segment can be represented mathematically as a vector, the “velocity vector”, V, for easier mathematical processing by the digital processing system 32. The velocity vector V, can be represented as V=Vₓi+V_{y}j+V_{z}k, where i, j, and k are unit vectors in the X, Y, and Z directions, respectively, and Vₓ, V_{y}, and V_{z}, having units of meters per second for example, are the components of the velocity vector V in the X, Y, and Z directions, respectively. Note that the magnitude of the velocity vector, V, can be computed from its directional components, Vₓ, V_{y}, and V_{z}, as:

|V|=\sqrt{Vₓ²+V_{y}²+V_{z}²} Equation 1

In step 106, the digital processing system 32 of the golf putting aid system 30 determines where the golf ball 64 will be on green 60 in a time Δt in the future based on the present location of the golf ball 64 and the present value of the velocity vector V. In particular, if X_{S} is the starting position of a trajectory segment and X_{E} is the ending position of a trajectory segment in the X-direction then X_{E}=X_{S}+VₓΔt. Similarly, if Y_{S} is the starting position of a trajectory segment and Y_{E} is the ending position of a trajectory segment in the Y-direction then Y_{E}=Y_{S}+V_{y}Δt. The ending point for the ball in the Z-axis for the same trajectory segment is determined by the topography of the green 60, determined earlier in step 102, as the golf ball 64 is assumed to follow the topography or contours of the green 60.

In step 108, the digital processing system 32 of the golf putting aid system 30 determines if the location of the golf ball 64 at the coordinates at the end of the segment, namely (X_{E},Y_{E}) computed in step 106 is substantially the same as the coordinates of the cup, (X_{C},Y_{C}) computed in step 104. Mathematically this determination can be computed as

D=\sqrt{(X_{E}−X_{C})²+(Y_{E}−Y_{C})²} Equation 2

where D is the distance between the center of the golf ball 64 and the center of the cup 62.

If in step 108 the digital processing system 32 of the golf putting aid system 30 determines the location of the golf ball 64 at the coordinates at the end of the segment, namely (X_{E},Y_{E}) computed in step 106 is substantially the same as the coordinates of the cup, (X_{C},Y_{C}) computed in step 104, e.g. in this example when value of D is less than a threshold value, such as 0.010 meters, then the golf ball 64 has reached the cup 62 and the Yes branch is taken to step 110.

In step 110, a trajectory 72 for the golf ball 64 that causes it to reach or land in the cup 62 has been computed by the digital processing system 32 of the golf putting aid system 30. Therefore, in the digital processing system 32 of the golf putting aid system 30 may stop computing trajectory, until another new trajectory is needed.

If back in step 108 the digital processing system 32 of the golf putting aid system 30 determines the location of the golf ball 64 at the coordinates at the end of the segment, namely (X_{E},Y_{E}) computed in step 106 is not substantially the same as the coordinates of the cup, (X_{C},Y_{C}) computed in step 104, e.g. if the value of D is greater than the threshold value then the golf ball 64 is not at the location of the cup 92 and the No branch is taken to step 112.

An additional test may be executed by the digital processing system 32 of the golf putting aid system 30 in step 108, wherein the digital processing system 32 of the golf putting aid system 30 determines if the velocity of the golf ball 64 is also less than a threshold velocity value, otherwise the golf ball 64 may be at the cup, but would jump over the cup 62 without falling into it if the velocity value is too great. The velocity is the magnitude of the velocity vector V, which is computed according to Equation 1. If the golf ball's 64 location is substantially at the location of the cup 62 (e.g., D is less than a threshold), but the velocity value of the golf ball 64 does not exceed the velocity threshold, such as 0.010 meters/second, for example, then the Yes branch would still be taken to step 110. However, if the golf ball's 64 location is substantially at the location of the cup 62 (e.g., D is less than a threshold), but the velocity value of the golf ball 64 exceeds the velocity threshold, such as 0.010 meters/second, for example, then the No branch would still be taken to step 112. It should be noted that in this example the word “reach” or “reached” is defined to mean that not only has the position of the golf ball has position become substantially the same as that of the cup 62, but that also the velocity of the golf ball 64 is slow enough that the golf ball 64 can fall into the cup 62 at the position of the cup 62 instead of passing over the opening of the cup 62.

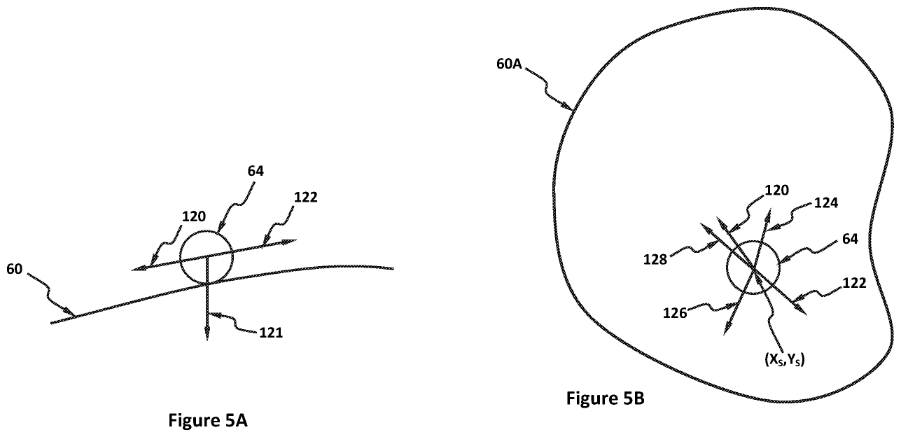

In step 112, the velocity vector V for the next trajectory segment is computed by the digital processing system 32 of the golf putting aid system 30. The starting coordinates (X_{S},Y_{S}) of the new velocity vector are set equal to the ending coordinates of the previous segment (X_{E},Y_{E}), i.e., X_{S}=X_{E} and Y_{S}=Y_{E}. Additionally in step 112, the direction and the magnitude of the new velocity vector may also be computed by the digital processing system 32 of the golf putting aid system 30, which is a function of the topography at location (X_{S},Y_{S}), the magnitude and direction of the previous velocity vector, the resistance offered by the surface of a green 60 to a rolling golf ball 64, and any other forces acting on the golf ball 64, such as the wind or grain of the green 60 at (X_{S},Y_{S}) by way of example only. Some of the possible forces that can be acting on the ball are shown vectorally in FIGS. 5A and 5B, and include gravity vector 121, which is in the downward direction but is manifested as the motion vector M 120 whose direction and magnitude includes the effects of gradient of the green 60 at (X_{S}, Y_{S}) which is determined from the topography of the green 60, resistance vector R 122 which is in the negative direction of the velocity vector V, the wind vector W 126, and any biases or grains in the surface of the green 60 represented as grain vector N 124.

Each of the forces, being represented as a vector, has X, Y, and Z components that can be added with other X, Y, and Z components, respectively, to determine the total force acting on the ball in each component direction. For example, in the X-direction the forces can be added as

X_{Total}=X_{M}+X_{R}+X_{W}+X_{N} Equation 3

where X_{Total} is the sum total of the forces acting on the ball in the X-direction, X_{M} is the X-component of the motion vector M 120, X_{R} is the X-component of the resistance vector R 122, X_{W} is the X-component of the wind vector W 126, and X_{N} is the X-component of the grain vector N 124.
Similarly, the Y-direction forces acting on the ball sum as shown in Equation 4:

Y_{Total}=Y_{M}+Y_{R}+Y_{W}+Y_{N} Equation 4

Note that it is not generally necessary to compute the forces acting on the ball in the Z-direction, e.g., Z_{Total}, because the motion of the ball in the Z-direction is dictated by the topography of the green 60.

The acceleration of the ball at each starting point of a trajectory segment can be computed by the digital processing system 32 of the golf putting aid system 30 from the well-known equation:

Force=Mass×Acceleration. Equation 5

Note that in Equation 5 the Force term is a vector and the Acceleration term is also a vector, and as such can be split into their respective components as shown in Equations 6 and 7, and include the total component forces developed in Equations 3 and 4, respectively:

Force_{X}=Mass×Acceleration_{X}=X_{Total} Equation 6

Force_{Y}=Mass×Acceleration_{Y}=Y_{Total} Equation 7

Rearranging Equations 6 and 7 results in Equation 8 and 9, respectively:

Acceleration_{X}=X_{Total}/Mass Equation 8

Acceleration_{Y}=Y_{Total}/Mass Equation 9

If the time increment Δt is sufficiently small then the change in velocity due to the acceleration can be computed from equation 10:

V_{E}−V_{S}=ΔV=Acceleration×Δt. Equation 10

Equation 10 can be broken apart for each of the two X and Y components and combined with Equations 6 and 7, respectively, resulting in:

ΔV_{X}=X_{Total}Δt/Mass Equation 11

ΔV_{Y}=Y_{Total}Δt/Mass. Equation 12

where the Mass term is the mass of the golf ball 64, being approximately 0.0459 kilograms, and ΔV_{X} is the change in velocity in the X-direction and ΔV_{Y} is the change in velocity in the Y-direction. The components of the new velocity vector (i.e., of the next segment of the computed trajectory 72) is therefore

V_{X}=V_{E,X}+ΔV_{X}=V_{E,X}+X_{Total}Δt/Mass Equation 13

V_{Y}=V_{E,Y}+ΔV_{Y}=V_{E,Y}+Y_{Total}Δt/Mass Equation 14

The new velocity vector V computed in Step 112 of FIG. 4 is thus

V=V_{X}i+V_{Y}j Equation 15

After the new velocity vector is computed in step 112 per Equation 15, then in step 114, the digital processing system 32 of the golf putting aid system 30 determines if the magnitude of new velocity vector V, determined in accordance with Equation 15 and Equation 1, has fallen below a threshold velocity. That is, in step 114 the digital processing system 32 of the golf putting aid system 30 whether the golf ball 64 has essentially stopped rolling. If in step 114 the digital processing system 32 of the golf putting aid system 30 determines the magnitude of the new velocity vector V has not fallen below a threshold (i.e., it has not stopped rolling), then the No branch is taken back to step 106 as illustrated and described earlier. If in step 114 the digital processing system 32 of the golf putting aid system 30 determines the magnitude of the new velocity vector V has fallen below a threshold such as 5 mm/second, for example, then the Yes branch is taken to step 116. In step 116, when the ball 64 has stopped rolling (as determined in step 114) and it has missed or skipped over the cup 62 (as determined in step 108).

In step 116, the digital processing system 32 of the golf putting aid system 30 determines based on an analysis of image data captured by the 3D imager device 40 or in other manners the ending location of the computed trajectory 72 (i.e., X_{E} and Y_{E} for final segment 72N) and compares to the coordinates of the cup 62 (X_{C},Y_{C}). If the length of the computed trajectory 72 is determined by the digital processing system 32 of the golf putting aid system 30 to significantly exceed the distance between a starting position 65 of the golf ball 64 and the cup 62 then the initial velocity estimate for segment 72A is reduced by the digital processing system 32 of the golf putting aid system 30. Alternately if the length of the computed trajectory 72 is determined by the digital processing system 32 of the golf putting aid system 30 to be significantly less than the distance between the starting position 65 of the golf ball 64 and the cup 62 then the initial velocity estimate for segment 72A is increased by the digital processing system 32 of the golf putting aid system 30. Additionally, if the ending location of the computed trajectory 72 is to the right of the cup 62 then the initial direction estimate for segment 72A is adjusted to the left by the digital processing system 32 of the golf putting aid system 30. Alternately if the ending location of the computed trajectory 72 is to the left of the cup 62 then the initial direction estimate for segment 72A is adjusted to the right by the digital processing system 32 of the golf putting aid system 30. Next the location of the new starting coordinates (X_{S},Y_{S}) of the golf ball 64 is reset by the digital processing system 32 of the golf putting aid system 30 to the starting point of the trajectory at segment 74A at ball starting position 75 and the golf ball 74 is re-launched along a velocity vector V having a new initial velocity and direction as determined in step 116 and this example may proceed back to step 106 as illustrated and described earlier to continue this example of the claimed technology.

In this example, the steps 106, 108, 112, 114, and 116 of FIG. 4 may be repeated by the digital processing system 32 of the golf putting aid system 30 with incrementally improved trajectories until one is found that causes the ball to reach the cup 62 at a low velocity such that the golf ball 64 drops into the cup 62.

Once a computed trajectory 72 has been found that causes a golf ball 64 at a ball starting position 65 to reach the cup 62 by the digital processing system 32 of the golf putting aid system 30, information about the computed trajectory 72 may be conveyed to the golfer 52, and possibly to others that are not the golfer 52 for educational and entertainment purposes. The conveyance of the computed trajectory 72 information can be through any of a golfer's senses, including visually, audibly, or tactilely. For example, if the information about computed trajectory 72 is conveyed visually by the digital processing system 32 of the golf putting aid system 30, the computed trajectory 72 can be shown in a display device 50, such as with a head-mounted display or a hand-held display, such as a mobile phone, handset, or tablet, or a larger non-portable display set on a table-top. The display device 50 can also be another one coupled to the digital processing system 32 of the golf putting aid system 30 remote to the green 60 and/or in addition to one for the golfer 52, such as a remote television seen by a distant television audience. Alternately, if the information about computed trajectory 72 is conveyed audibly, the computed trajectory 72 can be conveyed through an earphone device 48 to the golfer 52, such as in a mobile phone, handset, or tablet, or even a remote television speaker coupled to the digital processing system 32 of the golf putting aid system 30. Alternately, if the information about computed trajectory 72 is conveyed tactilely, the computed trajectory 72 can be conveyed through a golfer's putter 54 if so equipped with a vibrational tactile transducer 46 coupled to the digital processing system 32 of the golf putting aid system 30, for example, or through a mobile phone, handset, or tablet, which typically have built-in vibrational transducers.

An example of a method for using the golf putting aid system 30 will now be illustrated and described with reference to FIG. 7. In step 160, before the golfer 52 executes a putt, the golf putting aid system 30 may be activated and the 3D imager device 40 may be aimed, such that the field of view 56 encompasses or is intended to encompass the ball 64 laying on a green 60 at golf ball starting position 65, the cup 62, and at least that portion of the green 60 there between.

In step 162, the 3D imager device 40 of the golf putting aid system 30 is used to capture 3D image data of the green 60, the golf ball 60, and the cup 62, and this 3D image data is transmitted from the 3D imager device 40 to the digital processing system 32 of the golf putting aid system 30, although other types of image data may be captured. During this aiming process, the image data captured by the 3D imager device 40 may be presented on display device 50 by way of the digital processing system 32 of the golf putting aid system 30 to facilitate the aiming process until at least the portion of the green with the ball 64 and the cup 62 are within the field of view 50. As described earlier, the digital processing system 32 of the golf putting aid system 30 may execute image processing and object recognition on the captured data to determine when at least a portion of the green with the ball 64 and the cup 62 or other object or objects of interest are within the field of view 50.

In step 164, data about the green and/or an environment of the green 60 is sensed, captured, or otherwise input into the digital processing system 32 of the golf putting aid system 30, including by way of example only, data on a grain of the green 60 through keypad 34, speed or resistance data of the green 60 through a green speed meter device 36 coupled to or input keypad 34, inclination data of the 3D imager device 40 received from the inclinometer device 38, heading data from the compass device 42 indicating the direction that the 3D imager device 40 is pointing during the 3D imaging process, and wind speed and direction data from wind sensor device 44, although other types and/or numbers of environmental or other data related to the green 60 or putting or other process may be used. This data may be stored for example in memory 202 of digital processing system 32 for subsequent processing or may be used in real time.

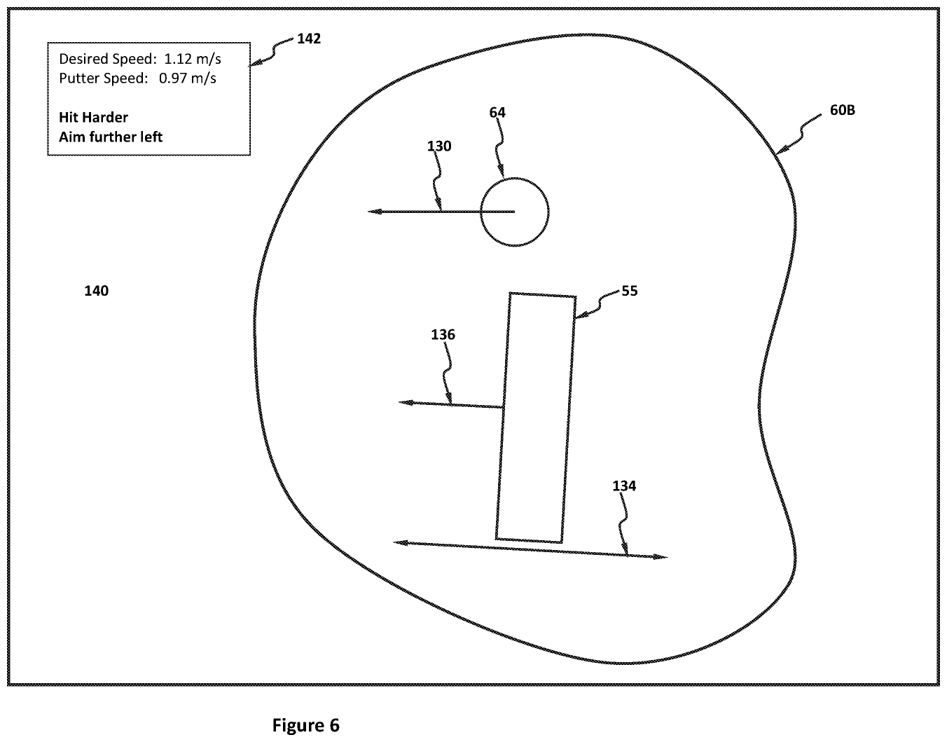

In step 166, the digital processing system 32 of the golf putting aid system 30 computes a computed trajectory 72 that golf ball 64 can follow from starting position 65 to reach the cup 62 based upon the data collected in steps 162 and 164, such as by way of example the method illustrated and described with reference to FIGS. 3 and 4 illustrated and described herein. The computed trajectory 72 can then be shown on display device 50 by the digital processing system 32 of the golf putting aid system 30, overlaid atop the green 60 if desired. This computed trajectory 72 may be shown overlaid in the display device 50 superimposed onto a displayed image of the green 60 and can move in accordance with the viewpoint of the golfer 52 as he or she moves, such movement being detected and measured by the compass device 42 which outputs heading information to the digital processing system 32 of the golf putting aid system 30 in real-time in this example so the digital processing system 32 of the golf putting aid system 30 can adjust the displayed image on display device 50 accordingly. Also, the desired aiming direction and speed (130 of FIG. 6) of the putt can be computed by digital processing system 32 and also shown overlaid in the display 46.

In step 168, as the golfer 52 approaches the golf ball 64 in preparation to make a putt, the digital processing system 32 of the golf putting aid system 30 may for example by virtue of 3D imager device 40 and/or one or more other sensors, such as inclinometer device 38 and compass device 42, process captured image data and/or other data, such as GPS data from a GPS device coupled to the digital processing system 32, and determine that the position of the golfer 52 is proximal to the golf ball 64. The digital processing system 32 of the golf putting aid system 30 may instruct the golfer 52—either through for example the display device 50, earphone device 48, and/or tactile transducer 46—to take a few practice swings of the putter 54. As the golfer 52 takes his or her practice swings, the 3D imager device 40 of golf putting aid system 30 may capture image data of the practice swings, transmits the 3D images to the digital processing system 32 which in turn computes direction and velocity of the putter head 55. The digital processing system 32 of the golf putting aid system 30 may also illustrate a comparison of the captured image data of the one or more practice swings to the desired initial direction and speed of the golf ball 64 determined earlier by the digital processing system 32 of the golf putting aid system 30 on display device 50, an example of which is shown in FIG. 6.

Referring to FIG. 6, the displayed image 140 presented to golfer 52 can include an image of the golf ball 64 and its computed desired launch vector 130 (which is essentially a representation of the initial velocity segment 72A) within a subset area 60B of green 60, an image of putting head 55 as well as putter swing indicator 134 which can be represented as a line or arrow parallel to the direction of the putt practice swing and whose length is proportional to the velocity of the putt head 55 during the practice swing. Also shown in displayed image 140 is anticipated launch vector 136 which is indicative of the how fast and in which direction a golf ball 64 will be hit if a practice swing was executed on the golf ball 64. The goal of the golfer 52 at this juncture is to have the direction and length of a desired launch vector 130 and anticipated launch vector 136 to be the same. If the desired launch vector 130 and anticipated launch vector 136 are substantially the same then the golf ball 64 will substantially follow computed trajectory 72 and reach the cup 62 when putted accordingly.

Referring back to FIG. 7, in step 170 the digital processing system 32 of golf putting aid system 30 determines if the desired launch vector 130 and the anticipated launch vector 136 are substantially identical, e.g. within a stored or otherwise set threshold difference. If the digital processing system 32 of golf putting aid system 30 determines the desired launch vector 130 and the anticipated launch vector 136 are not substantially identical, e.g. within a stored or otherwise set threshold difference, then a No branch can be taken to step 178.

In step 178, the digital processing system 32 of golf putting aid system 30 can provide visual feedback in the display device 50 in the form of textual data 142, indicating one or more corrective directions on how hard or where to hit the golf ball 64 (or equivalently, how to adjust the putter practice swings to accomplish that end), although other manners for providing corrective feedback may be used. In another example, the digital processing system 32 of golf putting aid system 30 can also provide corrective feedback information through earphone device 48 (e.g., the synthetic spoken words “hit harder” or “aim further left” can be heard in the earphone device 48), and/or tactilely in which the tactile transducer 46 may buzz, for example, when the desired launch vector 130 and the anticipated launch vector 136 are not substantially identical. After step 178, the digital processing system 32 of golf putting aid system 30 may proceed back to step 168 as illustrated and described earlier and this cycle may continue until the golfer 52 adjusts his practice swings so that the desired launch vector 130 and the anticipated launch vector 136 determined by the digital processing system 32 of golf putting aid system 30 are substantially the same, e.g. within a stored or otherwise set threshold.

If back in step 170 the digital processing system 32 of golf putting aid system 30 determines the desired launch vector 130 and the anticipated launch vector 136 are substantially identical, e.g. within a stored threshold difference, then the Yes branch can be taken to step 172. In step 172, after golfer 52 adjusts his practice swings such that the digital processing system 32 of golf putting aid system 30 determines the anticipated launch vector 136 substantially matches the desired launch vector 130, e.g. within a stored threshold difference, then the digital processing system 32 of golf putting aid system 30 can provide visual feedback, such as in the display in the form of textual data 142, indicating that the putt practice swings are optimal, although other types of feedback may be provided. By way of example, the digital processing system 32 of golf putting aid system 30 can also provide equivalent information through earphone device 48 (e.g., the synthetic spoken words “putt now” can be heard in the earphone device 48), or tactilely in which the tactile transducer 46 may stop buzzing, for example.

In step 174, in the golfer 52 may execute the optimized by the digital processing system 32 of golf putting aid system 30 for example the process illustrated and described in steps 168, 170, and 178. The digital processing system 32 of golf putting aid system may also capture 3D image data, by way of 3D imager 40, and digital processing system 32 of golf putting aid system 30 can determine the actual launch direction and initial speed of golf ball 64, and even the actual trajectory of golf ball 64, for later comparison to the prescribed launch vector and computed trajectory 72 for feedback to the golfer 52.

In step 176, this example of putting with the golf putting aid system 30 may end.

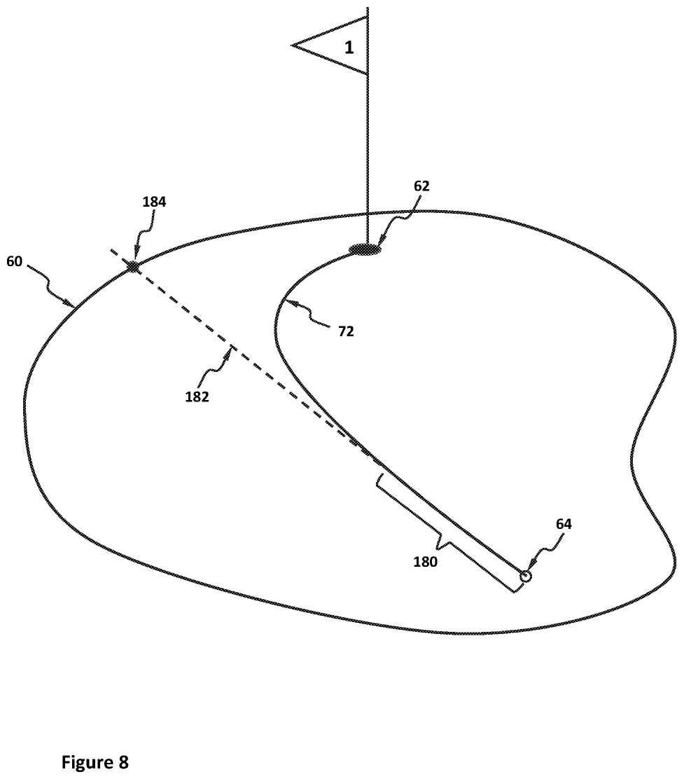

Referring now to FIG. 8, an example of an alternate way of visually presenting information relating to the trajectory assistance to move an object from a starting location to a destination location, such as where a golfer 52 should aim his or her putt in this example is illustrated in FIG. 8. In this example, the first portion of a trajectory 72 can be graphically and mathematically modelled as a straight line, shown as linear portion 180. The reason linear portion 180 is approximately linear is because the momentum due to the initial velocity of a putted golf ball is significantly greater than the other forces acting on the golf ball 64, such as those forces described in connection to FIGS. 5A and 5B, and consequently the initial path of trajectory 72 does not depart significantly from a straight line. The line of linear portion 180 can be extended, as shown by the dotted line extension 182 in FIG. 8, until the extension 182 reaches the edge of green 60, or even beyond the edge of green 60. But as shown in FIG. 8, an aiming point 184 is determined by digital processing system 32 to be the intersection of extension 182 and the edge of green 60, although other aiming points along extension 182 (both before the edge of the green 60 and beyond the edge of the green 60) can be determined as well. Note that the location of aiming point 184 can be determined in process step 166 of FIG. 7, and the position of aiming point 184 can be presented visually to a golfer 52 through display 50 in the latter half of process step 166 of FIG. 7.

Although in the example herein the terms “green” or “golf green” are used and generally apply to a golf putting aid 30, the terms “green” or “golf green” can be replaced and examples of this technology may be used on any playing surface of interest over which a trajectory is to be computed in accordance with this example. It should be further noted that while the terms “ball” or “golf ball” are used and generally apply to a golf putting aid 30, the terms “ball” or “golf ball” can be replaced and examples of this technology may be used to work with any substantially spherical object whose trajectory is to be computed in accordance with this example as it rolls across a surface of interest. Finally, it should be further noted that while the term “cup” is used and generally applies to a golf putting aid 30, the term “cup” can be replaced and examples of this technology may be used to include any destination of a spherical object whose trajectory is to be computed in accordance with this example as it rolls across or otherwise travels along or above a surface of interest.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, such as arrows in the diagrams therefore, is not intended to limit the claimed processes to any order or direction of travel of signals or other data and/or information except as may be specified in the claims. Accordingly, the invention is limited only by the following claims and equivalents thereto.

What is claimed is:

1. A trajectory assistance system, comprising:
at least one processor;
an image capturing device and an interface system coupled to the at least one processor;
a memory coupled to the processor which is configured to be capable of executing programmed instructions comprising and stored in the memory to:
capture, with the image capture device, image data comprising a surface, an object, and a designated location spaced from the object on the surface;
determine spatial data and surface data relating to the surface, the object and the designated location;
compute an overall trajectory, a starting direction, and an initial velocity of the object to reach the designated location; and
provide, with the interface system, the computed overall trajectory, the starting direction, and the initial velocity of the object.

2. The system as set forth in claim 1 wherein for the capture image data, the processor is further configured to be capable of executing the stored programmed instructions to:
capture, with the image capture device, three-dimensional image data comprising at least one of the surface, the object, or the designated location spaced from the object on the surface.

3. The system as set forth in claim 2 wherein for the capture image data, the processor is further configured to be capable of executing the stored programmed instructions to:
execute object recognition on the image data to determine when the object and the designated location are in the image data; and
continue to capture additional image data until the executed object recognition on the additional image data determines the object and the designated location are in the additional image data.

4. The system as set forth in claim 1 wherein for the determine spatial data and surface data relating to the surface, the object and the designated location, the processor is further configured to be capable of executing the stored programmed instructions to:
determine at least one type of weather element data.

5. The system as set forth in claim 4 wherein for the determine at least one type of the weather element data, the processor is further configured to be capable of executing the stored programmed instructions to:
obtain, with a wind sensor coupled to the at least one processor, wind data on the surface;
wherein the compute the overall trajectory, the starting direction, and the initial velocity of the object to reach the designated location is further based on the obtained wind data.

6. The system as set forth in claim 2 wherein for the determine the spatial data, the processor is further configured to be capable of executing the stored programmed instructions to:
determine based on the three-dimensional image data at least a distance and any elevation difference between the object and the designated location on the surface;
wherein the compute the overall trajectory, the starting direction, and the initial velocity of the object to reach the designated location is further based on the determined distance and any elevation difference.

7. The system as set forth in claim 1 wherein for the determine surface data, the processor is further configured to be capable of executing the stored programmed instructions to:
obtain green speed data related to the surface;
wherein the compute the overall trajectory, the starting direction, and the initial velocity of the object to reach the designated location is further based on the obtained green speed data.

8. The system as set forth in claim 1 wherein for the determine surface data, the processor is further configured to be capable of executing the stored programmed instructions to:
receive, with the interface system, an input of green grain data between the object and the designated location on the surface;
wherein the compute the overall trajectory, the starting direction, and the initial velocity of the object to reach the designated location is further based on the obtained green grain data.

9. The system as set forth in claim 1 wherein the processor is further configured to be capable of executing the stored programmed instructions to:
capture, with the image capture device, practice image data of at least one practice swing with a sporting device to simulate a practice speed and practice direction;
compute the practice trajectory, the practice direction, and the practice velocity of the object to reach the designated location;
compare the practice trajectory, the practice direction, and the practice velocity of the object against the computed overall trajectory, the starting direction, and the initial velocity of the object; and
provide, with the interface system, feedback data based on the comparison.

10. The system as set forth in claim 1 wherein for the provide the feedback data, the processor is further configured to be capable of executing the stored programmed instructions to:
display, with a display device coupled to the at least one processor, the practice trajectory and the computed overall trajectory.

11. The system as set forth in claim 1 wherein for the provide the feedback data, the processor is further configured to be capable of executing the stored programmed instructions to:
provide, with a tactile transducer device coupled to the at least one processor, tactile feedback relating to the at least one of the practice direction or the practice velocity of the object with respect to a corresponding one of the starting direction or the initial velocity of the object.

12. The system as set forth in claim 1 wherein for the provide the feedback data, the processor is further configured to be capable of executing the stored programmed instructions to:
provide, with at least one speaker device coupled to the at least one processor, audio feedback relating to the at least one of the practice direction or the practice velocity of the object with respect to a corresponding one of the starting direction or the initial velocity of the object.

13. A non-transitory computer readable medium having stored thereon instructions comprising executable code which when executed by at least one processor, cause the processor to:
obtain image data comprising a surface, an object, and a designated location spaced from the object on the surface;
determine spatial data and surface data relating to the surface, the object and the designated location;
compute an overall trajectory, a starting direction, and an initial velocity of the object to reach the designated location; and
provide the computed overall trajectory, the starting direction, and the initial velocity of the object.

14. The medium as set forth in claim 13 wherein for the capture image data, the executable code, when executed by the processor, further causes the processor to:
obtain three-dimensional image data comprising at least one of the surface, the object, or the designated location spaced from the object on the surface.

15. The medium as set forth in claim 14 wherein for the capture image data, the executable code, when executed by the processor, further causes the processor to:
execute object recognition on the image data to determine when the object and the designated location are in the image data; and
continue to capture additional image data until the executed object recognition on the additional image data determines the object and the designated location are in the additional image data.

16. The medium as set forth in claim 13 wherein for determine spatial data and surface data relating to the surface, the object and the designated location, the executable code, when executed by the processor, further causes the processor to:
determine at least one type of weather element data.

17. The medium as set forth in claim 16 wherein for the determine at least one type of the weather element data, the executable code, when executed by the processor, further causes the processor to:
obtain wind data on the surface;
wherein the compute the overall trajectory, the starting direction, and the initial velocity of the object to reach the designated location is further based on the obtained wind data.

18. The medium as set forth in claim 14 wherein for the determine the spatial data, the executable code, when executed by the processor, further causes the processor to:
determine based on the three-dimensional image data at least a distance and any elevation difference between the object and the designated location on the surface;
wherein the compute the overall trajectory, the starting direction, and the initial velocity of the object to reach the designated location is further based on the determined distance and any elevation difference.

19. The medium as set forth in claim 13 wherein for the determine surface data, the executable code, when executed by the processor, further causes the processor to:
obtain green speed data related to the surface;
wherein the compute the overall trajectory, the starting direction, and the initial velocity of the object to reach the designated location is further based on the obtained green speed data.

20. The medium as set forth in claim 13 wherein for the determine surface data, the executable code, when executed by the processor, further causes the processor to:
receive an input of green grain data between the object and the designated location on the surface;
wherein the compute the overall trajectory, the starting direction, and the initial velocity of the object to reach the designated location is further based on the obtained green grain data.

21. The medium as set forth in claim 13 wherein the executable code, when executed by the processor, further causes the processor to:
obtain practice image data of at least one practice swing with a sporting device to simulate a practice speed and practice direction;
compute the practice trajectory, the practice direction, and the practice velocity of the object to reach the designated location;
compare the practice trajectory, the practice direction, and the practice velocity of the object against the computed overall trajectory, the starting direction, and the initial velocity of the object; and
provide feedback data based on the comparison.

22. The medium as set forth in claim 13 wherein for the provide the feedback data, the processor is further configured to be capable of executing the stored programmed instructions to:
display the practice trajectory and the computed overall trajectory.

23. The medium as set forth in claim 13 wherein for the provide the feedback data, the executable code, when executed by the processor, further causes the processor to:
engage a tactile transducer device to provide tactile feedback relating to the at least one of the practice direction or the practice velocity of the object with respect to a corresponding one of the starting direction or the initial velocity of the object.

24. The medium as set forth in claim 13 wherein for the provide the feedback data, the executable code, when executed by the processor, further causes the processor to:
engage with at least one speaker device to provide audio feedback relating to the at least one of the practice direction or the practice velocity of the object with respect to a corresponding one of the starting direction or the initial velocity of the object.

25. A method comprising:
capturing, by an image capture device coupled to a computing device, image data comprising at least one of a surface, a ball, or a designated location spaced from the object on the surface;
determining, by the computing device, spatial data and surface data relating to the surface, the object and the designated location;
computing, by the computing device, an overall trajectory, a starting direction, and an initial velocity of the object to reach the designated location; and
providing, by an interface system coupled to the computing device, the computed overall trajectory, the starting direction, and the initial velocity of the object.

26. The method as set forth in claim 25 wherein the capturing image data further comprises:
capturing, by the image capture device coupled to a computing device, three-dimensional image data comprising at least one of the surface, the object, or the designated location spaced from the object on the surface.

27. The method as set forth in claim 25 wherein the capturing image data, further comprises:
executing, by the computing device, object recognition on the image data to determine when the object and the designated location are in the image data; and
continuing to capture, by the computing device, additional image data until the executed object recognition on the additional image data determines the object and the designated location are in the additional image data.

28. The method as set forth in claim 25 wherein for the determining spatial data and surface data relating to the surface, the object and the designated location, the executable code, when executed by the processor, further causes the processor to:
determine at least one type of weather element data.

29. The method as set forth in claim 28 wherein the determining at least one type of the weather element data further comprises:
obtaining, by a wind sensor coupled to the computing device, wind data on the surface;
wherein the compute the overall trajectory, the starting direction, and the initial velocity of the object to reach the designated location is further based on the obtained wind data.

30. The method as set forth in claim 26 wherein the determining the spatial data, further comprises:
determining, by the computing device, based on the three-dimensional image data at least a distance and any elevation difference between the object and the designated location on the surface;
wherein the computing the overall trajectory, the starting direction, and the initial velocity of the object to reach the designated location is further based on the determined distance and any elevation difference.

31. The method as set forth in claim 25 wherein the determining surface data further comprises:
obtaining, by the computing device, green speed data related to the surface;
wherein the compute the overall trajectory, the starting direction, and the initial velocity of the object to reach the designated location is further based on the obtained green speed data.

32. The method as set forth in claim 25 wherein the determining surface data further comprises:
receiving, by the interface system coupled to the computing device, an input of green grain data between the object and the designated location on the surface;
wherein the computing the overall trajectory, the starting direction, and the initial velocity of the object to reach the designated location is further based on the obtained green grain data.

33. The method as set forth in claim 25 further comprising:
capturing, by the image capture device coupled to the computing device, practice image data of at least one practice swing with a sporting device to simulate a practice speed and practice direction;
computing, by the computing device, the practice trajectory, the practice direction, and the practice velocity of the object to reach the designated location;
comparing, by the computing device, the practice trajectory, the practice direction, and the practice velocity of the object against the computed overall trajectory, the starting direction, and the initial velocity of the object; and
provide, by the interface system coupled to the computing device, feedback data based on the comparison.

34. The method as set forth in claim 25 wherein the providing the feedback data further comprises:
displaying, with a display device coupled to the computing device, the practice trajectory and the computed overall trajectory.

35. The method as set forth in claim 25 wherein the providing the feedback data, further comprises:
providing, with a tactile transducer device coupled to the computing device, tactile feedback relating to the at least one of the practice direction or the practice velocity of the object with respect to a corresponding one of the starting direction or the initial velocity of the object.

36. The method as set forth in claim 25 further comprising:
providing, by at least one speaker device coupled to the computing device, audio feedback relating to the at least one of the practice direction or the practice velocity of the object with respect to a corresponding one of the starting direction or the initial velocity of the object.
